(19) United States
(12) Patent Application Publication
(10) Pub. No.: US 2022/0091769 A1
(43) Pub. Date: Mar. 24, 2022

(54) METHOD, DEVICE AND COMPUTER PROGRAM PRODUCT FOR MANAGING STORAGE POOL

(71) Applicant: EMC IP Holding Company LLC, Hopkinton, MA (US)

(72) Inventors: Bo Hu, Chengdu (CN); Qian Wu, Chengdu (CN); Jing Ye, Chengdu (CN)

(21) Appl. No.: 17/166,255

(22) Filed: Feb. 3, 2021

(30) Foreign Application Priority Data
Sep. 23, 2020 (CN) 202011011638.7

(51) Int. Cl. G06F 3/06

(52) U.S. Cl. CPC G06F 3/0644; G06F 3/0689; G06F 3/0614; G06F 3/065

(57) ABSTRACT

Techniques involve: if it is detected that a storage pool fails, determining the number of failed storage devices in the storage pool; if it is determined that the number reaches a threshold number, determining whether the redundancy of the storage pool can be increased, the redundancy indicating the number of failed storage devices allowed without causing data loss in the storage pool; and if it is determined that the redundancy of the storage pool can be increased, adjusting at least part of a storage space for storing user data of the storage pool to a spare space of the storage pool to store data in a storage device that fails in the future. Accordingly, the probability of data loss can be reduced and the use of existing storage devices of a storage pool can be optimized.

### CROSS-REFERENCE TO RELATED APPLICATION

This application claims priority to Chinese Patent Application No. CN202011011638.7, on file at the China National Intellectual Property Administration (CNIPA), having a filing date of Sep. 23, 2020, and having “METHOD, DEVICE AND COMPUTER PROGRAM PRODUCT FOR MANAGING STORAGE POOL” as a title, the contents and teachings of which are herein incorporated by reference in their entirety.

### TECHNICAL FIELD

Embodiments of the present disclosure generally relate to the field of storage, and more particularly, to a method for managing a storage pool, a device, and a computer program product.

### BACKGROUND

In the field of storage, storage pools with mapped redundant arrays of independent disks are often used to store data. However, for a storage pool of a specific type, the number of failed storage devices allowed by the storage pool is fixed without causing data loss in the storage pool. When the number of failed storage devices in the storage pool reaches the allowable number, and the failed storage devices are not replaced by new storage devices, data loss may occur in the storage pool. In some cases, for example, the limited budget of an enterprise, the long purchase cycle of a storage device, etc., the failed storage devices cannot be replaced in time, which will increase the risk of data loss.

### SUMMARY OF THE INVENTION

The embodiments of the present disclosure provide a method for managing a storage pool, a device, and a computer program product.

In a first aspect of the present disclosure, a method for managing a storage pool is provided. The method includes: if it is detected that a storage pool fails, determining the number of failed storage devices in the storage pool; if it is determined that the number reaches a threshold number, determining whether the redundancy of the storage pool can be increased, the redundancy indicating the number of failed storage devices allowed without causing data loss in the storage pool; and if it is determined that the redundancy of the storage pool can be increased, adjusting at least part of a storage space for storing user data of the storage pool to a spare space of the storage pool to store data in a storage device that fails in the future.

In a second aspect of the present disclosure, an electronic device is provided. The electronic device includes: at least one processing unit; and at least one memory coupled to the at least one processing unit and storing instructions configured to be executed by the at least one processing unit. The instructions, when executed by the at least one processing unit, cause the device to perform actions including: if it is detected that a storage pool fails, determining the number of failed storage devices in the storage pool; if it is determined that the number reaches a threshold number, determining whether the redundancy of the storage pool can be increased, the redundancy indicating the number of failed storage devices allowed without causing data loss in the storage pool; and if it is determined that the redundancy of the storage pool can be increased, adjusting at least part of a storage space for storing user data of the storage pool to a spare space of the storage pool to store data in a storage device that fails in the future.

In a third aspect of the present disclosure, a computer program product is provided. The computer program product is tangibly stored in a non-transitory computer storage medium and includes machine-executable instructions. The machine-executable instructions, when being executed by a device, cause this device to implement any step of the method described according to the first aspect of the present disclosure.

The summary part is provided to introduce the choice of concepts in a simplified form, which will be further described in the following Detailed Description. The summary part is neither intended to identify important features or essential features of the present disclosure, nor intended to limit the scope of the present disclosure.

### BRIEF DESCRIPTION OF THE DRAWINGS

By description of example embodiments of the present disclosure in more detail with reference to the accompanying drawings, the above and other objectives, features, and advantages of the present disclosure will become more apparent. In the example embodiments of the present disclosure, the same reference numerals generally represent the same components.

FIG. 1 shows a block diagram of an example storage pool management system in which an embodiment of the present disclosure can be implemented;

FIG. 2 shows a schematic diagram of an example storage pool applicable to an embodiment of the present disclosure;

FIG. 3 shows a flowchart of an example method for managing a storage pool according to an embodiment of the present disclosure;

FIG. 4 shows a flowchart of an example method for adjusting at least part of a storage space of a storage pool to a spare space according to an embodiment of the present disclosure;

FIG. 5A shows a schematic diagram of a storage pool before the adjustment of at least part of a storage space of the storage pool to a spare space;

FIG. 5B shows a schematic diagram of a storage pool during the adjustment of at least part of a storage space of the storage pool to a spare space;

FIG. 5C shows a schematic diagram of a storage pool after the adjustment of at least part of a storage space of the storage pool to a spare space; and

FIG. 6 is a schematic block diagram of an example device that may be configured to implement an embodiment of the present disclosure.

In the accompanying drawings, the same or corresponding numerals represent the same or corresponding parts.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

Preferred embodiments of the present disclosure will be described in more detail below with reference to the accompanying drawings. Although the preferred embodiments of the present disclosure are shown in the accompanying drawings, it should be understood that the present disclosure can be implemented in various forms and should not be limited by the embodiments set forth herein. Rather, these embodiments are provided to make the present disclosure more thorough and complete and to fully convey the scope of the present disclosure to those skilled in the art.

The term “include” and its variants as used herein indicate open-ended inclusion, that is, “including, but not limited to.” Unless specifically stated, the term “or” indicates “and/or.” The term “based on” indicates “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects. Other explicit and implicit definitions may also be included below.

In the field of storage, storage pools with mapped Redundant Arrays of Independent Disks (RAID) are often used to store data. Such storage pools are called dynamic pools. The dynamic pool helps to achieve the following objectives: first, by adding parallelism to a reconstruction process and allowing the reconstruction performance to increase with the increase in the number of storage devices, the reconstruction time is shortened; second, a storage pool plan is improved to enable a storage pool to be created and expanded more based on the required capacity (expansion can be one storage device at a time); and third, backup management may be performed without a dedicated spare storage device. In the meantime, a spare space is allocated across storage devices in the storage pool, thereby reducing flash memory loss and improving array performance.

By removing the dedicated spare storage device without reducing memory redundancy, the dynamic pool may significantly benefit some enterprise users, such as start-up users with limited budgets and unpredictable business growth. Herein, “redundancy” refers to a maximum number of failed storage devices allowed by the storage pool without causing data loss in the storage pool. “Current redundancy” refers to the number of failed storage devices that can be allowed by the storage pool without causing data loss in the storage pool. As the business grows, RAID groups (RG) of different sizes may be created in the storage pool.

However, for a storage pool of a specific type, the number of failed storage devices allowed by the storage pool is fixed without causing data loss in the storage pool. When the number of failed storage devices in the storage pool reaches the allowable number, and the failed storage devices are not replaced by new storage devices, data loss may occur in the storage pool. In some cases, for example, the limited budget of an enterprise, the long purchase cycle of a storage device, etc., the failed storage devices cannot be replaced in time, which will increase the risk of data loss.

The embodiments of the present disclosure provide a solution for managing a storage pool, so as to solve the above problems and one or more of other potential problems. The solution adjusts at least part of a storage space for storing user data in a storage pool to a spare space of the storage pool, which can increase the redundancy of the storage pool, thereby increasing the redundancy of the storage pool without replacing failed storage devices and significantly reducing the probability of data loss. In addition, since the probability of data loss is reduced when the failed storage devices are not replaced, the cost of users purchasing storage devices is reduced, and the use of existing storage devices in the storage pool is optimized.

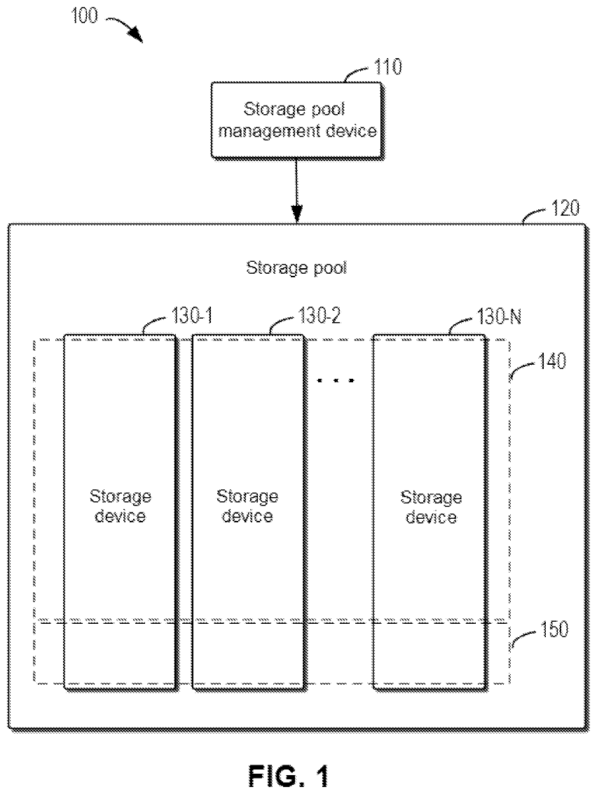

FIG. 1 shows a block diagram of example storage pool management system 100 in which an embodiment of the present disclosure can be implemented. As shown in FIG. 1, storage pool management system 100 includes storage pool management device 110 and storage pool 120. The storage pool includes storage devices 130-1 to 130-N (collectively referred to as storage device 130). Storage space 140 and spare space 150 of the storage pool are distributed across storage device 130, and storage space 140 includes a plurality of disk array groups (not shown). Various methods according to the embodiments of the present disclosure may be implemented at storage pool management device 110. It should be understood that the structure of storage pool management system 100 is described for example purposes only, and does not imply any limitation on the scope of the present disclosure. For example, the embodiments of the present disclosure may also be applied to a system different from storage pool management system 100. It should be understood that the specific number of the above devices and apparatuses is given for illustrative purposes only, and does not imply any limitation to the scope of the present disclosure. For example, the embodiments of the present disclosure may also be applied to more or fewer devices and apparatuses.

Storage pool management device 110 may determine the number of failed storage devices in storage pool 120 when it is detected that storage pool 120 fails. When it is determined that the number reaches a threshold number and the redundancy of storage pool 120 can be increased, storage pool management device 110 may adjust at least part of storage space 140 for storing user data in storage pool 120 to spare space 150 of storage pool 120 to store data in a storage device that fails in the future.

Storage pool management device 110 may be, for example, a computer, a virtual machine, a server, or the like, and the present disclosure is not limited in this regard. Storage device 130 may be, for example, a hard disk, a floppy disk, a disk, or the like, and the present disclosure is not limited in this regard. Storage pool management device 110 and storage pool 120 communicate with each other via a network. The network may be, for example, the Internet or an intranet.

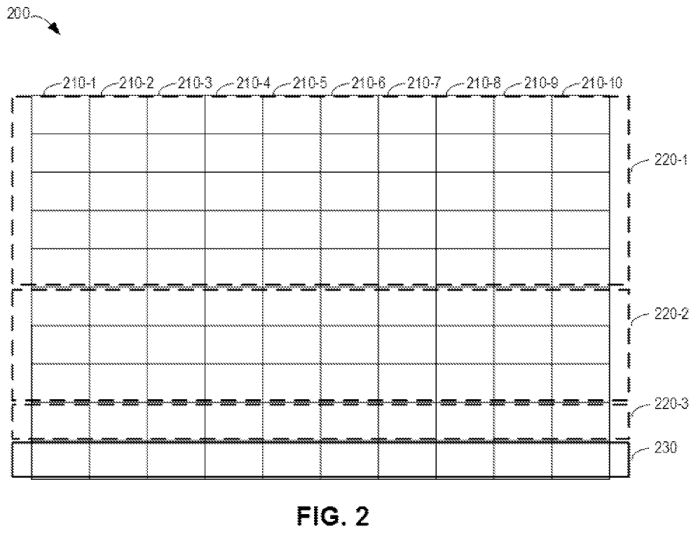

FIG. 2 shows schematic diagram 200 of an example storage pool applicable to an embodiment of the present disclosure. As shown in FIG. 2, storage pool 200 includes 10 storage devices, represented by 210-1 to 210-10, respectively. In other words, each column represents one storage device 210. The space size of each storage device 210 is the same. Three disk array groups are provided on a part of storage device 210 and are represented by 220-1 to 220-3, respectively. Three disk array groups 220 are respectively distributed across storage device 210 and collectively constitute the storage space of storage pool 200. A part of storage device 210 is set as spare space 230. Spare space 230 is configured to store data in the failed storage device when storage device 210 in storage pool 200 fails. As shown in FIG. 2, each storage device 210 is divided into 10 parts of the same size. The first nine parts are set as the storage space, and the last part is set as the spare space.

In the example shown in FIG. 2, it is assumed that the redundancy of storage pool 200 is 1. When storage devices 210 in storage pool 200 are all working normally, user data is stored in disk array group 220, and spare space 230 is empty. When one of the storage devices, such as storage device 210-10, fails, data in failed storage device 210-10 is replicated to spare space 230. In this case, the current redundancy of storage pool 210 is 0, and the redundancy of 1 is not restored until the failed storage device is replaced with a new storage device and data reconstruction is completed. Before the failed storage device is replaced, if another storage device, such as storage device 210-9, fails, there is no spare space 230 to store data in failed storage device 210-9, so data loss (DL) will occur.

In conventional implementations, a storage pool of a specific type has a certain redundancy. In other words, the number of failed storage devices allowed by a storage pool of a specific type is fixed without causing data loss in the storage pool. For example, for an RAID 5-type storage pool, the redundancy is 1. For an RAID 6-type storage pool, the redundancy is 2.

It should be understood that the example storage pool is shown for example purposes only and does not imply any limitation to the scope of the present disclosure. For example, the storage pool may also include more or fewer storage devices. More or fewer disk array groups may also be provided on the storage device. The size of the disk array groups may be the same or different. The present disclosure is not limited in this regard.

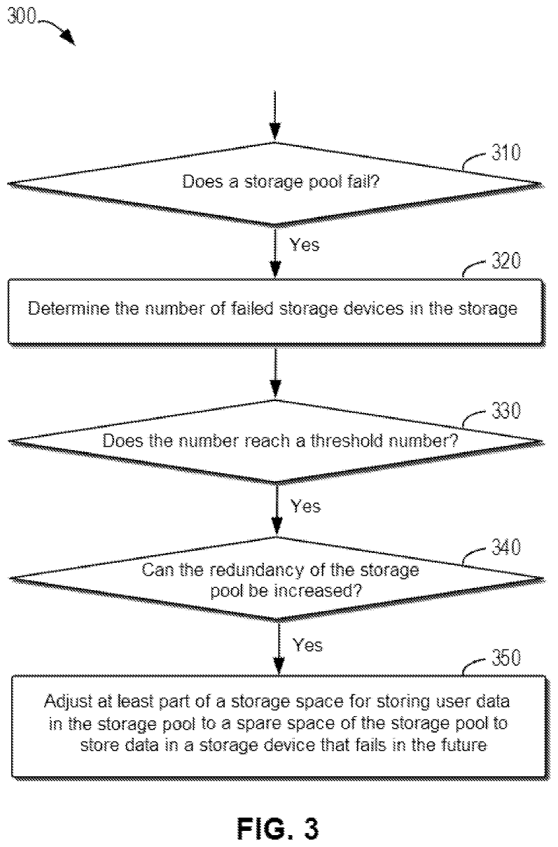

FIG. 3 shows a flowchart of example method 300 for managing a storage pool according to an embodiment of the present disclosure. For example, method 300 may be performed by storage pool management device 110 as shown in FIG. 1. It should be understood that method 300 may also be executed by other devices. The scope of the present disclosure is not limited in this regard. It should be further understood that method 300 may further include additional actions that are not shown and/or may omit actions that are shown. The scope of the present disclosure is not limited in this regard.

At 310, storage pool management device 110 detects whether storage pool 120 fails. In some embodiments, storage pool management device 110 may periodically detect whether storage device 130 in storage pool 120 fails. Additionally or alternatively, in some embodiments, storage pool management device 110 may receive a notification indicating that storage pool 120 fails when storage device 130 in storage pool 120 fails.

If storage pool management device 110 detects that storage pool 120 fails, at 320, storage pool management device 110 determines the number of failed storage devices in storage pool 120. In some embodiments, storage pool management device 110 may provide a counter to indicate the number of failed storage devices. For example, whenever storage pool management device 110 detects that a certain storage device 130 in storage pool 120 fails, the counter is increased by one. Additionally or alternatively, in some embodiments, storage pool management device 110 may set a status identifier to indicate the status of each storage device 130 in storage pool 120, and use the status identifier to determine the number of failed storage devices.

As mentioned above, the number of failed storage devices allowed by a storage pool of a specific type is fixed without causing data loss in the storage pool. For example, for an RAID 5-type storage pool, the redundancy is 1, that is, the number of failed storage devices allowed by this type of storage pool is 1 without causing data loss in the storage pool. Similarly, for an RAID 6-type storage pool, the redundancy is 2, that is, the number of failed storage devices allowed by this type of storage pool is 2 without causing data loss in the storage pool. Therefore, at 330, storage pool management device 110 determines whether the number of failed storage devices in storage pool 120 reaches a threshold number, and if it is determined that the number reaches the threshold number, at 340, storage pool management device 110 determines whether the redundancy of storage pool 120 can be increased. The redundancy indicates the number of failed storage devices allowed without causing data loss in storage pool 120.

In some embodiments, the threshold number may be set as the number of failed storage devices allowed by storage pool 120 without causing data loss. For example, for an RAID 5-type storage pool, the threshold number may be set as 2. In this case, when the number of failed storage devices in storage pool 120 reaches the threshold number, if the operation of increasing redundancy described below is not performed, when more storage devices fail, data loss will occur to the storage pool.

Alternatively, in some embodiments, the threshold number may be set to be less than the number of failed storage devices allowed by storage pool 120 without causing data loss. For example, for an RAID 5-type storage pool, the threshold number may be set as 1. In this case, when the number of failed storage devices in storage pool 120 reaches the threshold number, storage pool 120 can actually allow more storage devices to fail without causing data loss. In this case, the operation of increasing redundancy described below may still be performed to further increase the redundancy of storage pool 120.

As will be described in detail below, since the operation of increasing redundancy is to adjust at least part of storage space 140 for storing user data in storage pool 120 to spare space 150 of storage pool 120, storage pool management device 110 first determines whether the redundancy of storage pool 120 can be increased before executing the adjustment operation, so that the probability of failure of a redundancy increase operation is reduced, and thereby avoiding unnecessary impact on the performance of the storage pool.

In some embodiments, storage pool management device 110 may determine whether storage pool 120 is accessible and there is no ongoing data replication process. It is easy to understand that if storage pool 120 is inaccessible, for example, storage pool 120 is offline, storage pool management device 110 cannot perform the operation of increasing the redundancy of storage pool 120. In addition, as will be described in detail below, since the operation of increasing the redundancy of storage pool 120 involves data replication between disk array groups in storage pool 120, storage pool management device 110 determines that the redundancy of storage pool 120 cannot be increased if there is an ongoing data replication process in storage pool 120. Otherwise, if the operation of increasing the redundancy of storage pool 120 is performed while there is an ongoing data replication process in storage pool 120, the performance of storage pool 120 will be affected.

Additionally or alternatively, in some embodiments, if storage pool management device 110 determines that storage pool 120 is accessible and there is no ongoing data replication process, storage pool management device 110 may determine whether there is a target disk array group in a plurality of disk array groups distributed across storage device 130 in storage pool 120. The size of first data stored in the target disk array group is less than or equal to the size of a free storage space of the remaining disk array groups in the plurality of disk array groups.

In order to adjust at least part of storage space 140 of storage pool 120 to spare space 150 of storage pool 120, storage pool management device 110 needs to select a disk array group from a plurality of disk array groups, replicate user data in the selected disk array group to other disk array groups, and then release the storage space of the selected disk array group. Therefore, the size of the free storage space of other disk array groups must be large enough to accommodate the user data stored in the selected disk array group, otherwise the operation of adjusting at least part of the storage space to the spare space will result in data loss. In some embodiments, storage pool management device 110 may check data blocks of a fixed size in each disk array group in storage pool 120 to determine the size of data stored in each disk array group. These data blocks of a fixed size are sometimes also called “slices.” Then, storage pool management device 110 may determine whether there is a target disk array group in the plurality of disk array groups, so as to realize the replication of data in the target disk array group to other disk array groups without causing data loss.

Additionally, in some embodiments, storage pool management device 110 may estimate whether there is enough free storage space in the storage pool to accommodate the data stored in the target disk array group according to a historical storage space consumption rate.

Additionally, in some embodiments, storage pool management device 110 may determine a disk array group with the smallest storage space occupied by the stored data from the plurality of disk array groups, and then, storage pool management device 110 may determine the disk array group as the target disk array group. In such an embodiment, since the data in the disk array group to be replicated is minimum, resources occupied by the replication operation are minimum, so that the impact of the operation of increasing redundancy on the storage pool is minimized.

If storage pool management device 110 determines that the redundancy of storage pool 120 can be increased, at 350, storage pool management device 110 adjusts at least part of storage space 140 for storing user data in storage pool 120 to spare space 150 of storage pool 120 to store data in a storage device that fails in the future.

In some embodiments, storage pool management device 110 may determine a target disk array group from a plurality of disk array groups, and then set a part of a storage space of the target disk array group as a spare space.

Additionally, in some embodiments, storage pool management device 110 determines whether a request for increasing the redundancy is received after determining that the redundancy of storage pool 120 can be increased. If it is determined that a request for increasing the redundancy is received, storage pool management device 110 adjusts at least part of storage space 140 of storage pool 120 to spare space 150.

For example, storage pool management device 110 may generate a user interface to receive a request for increasing the redundancy after determining that the redundancy of storage pool 120 can be increased. In such an embodiment, a user may determine whether to send a request for increasing the redundancy of storage pool 120 to storage pool management device 110 as needed. For example, when the user has a limited budget and does not plan to purchase a new storage device to replace a failed storage device, or when the user finds that the space of the storage pool is usually greater than daily storage space requirements, the user may send a request for increasing the redundancy of storage pool 120 to storage pool management device 110 to sacrifice a part of the storage space of storage pool 120 to increase the redundancy of storage pool 120. Conversely, if the user does not want to reduce the storage space of storage pool 120, the user may choose not to increase the redundancy of storage pool 120 as needed even if the redundancy of storage pool 120 can be increased.

Additionally or alternatively, in some embodiments, if storage pool management device 110 does not receive a request for not to increase the redundancy within a predetermined period of time after determining that the redundancy of storage pool 120 can be increased, storage pool management device 110 automatically adjusts the storage space described above. In the above embodiments, the user may flexibly decide whether to increase the redundancy of the storage pool as needed.

In the above example embodiment, at least part of a storage space for storing user data in a storage pool is adjusted to a spare space of the storage pool, which can increase the redundancy of the storage pool, thereby increasing the redundancy of the storage pool without replacing failed storage devices and significantly reducing the probability of data loss.

In addition, since the probability of data loss is reduced when the failed storage devices are not replaced, the cost of users purchasing storage devices is reduced, and the use of existing storage devices in the storage pool is optimized.

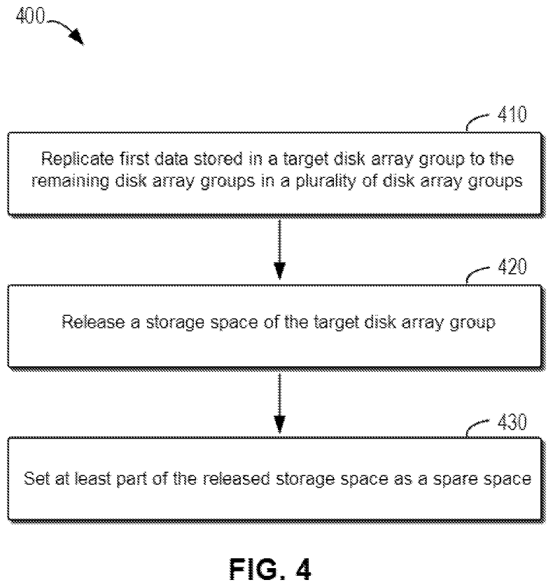

FIG. 4 shows a flowchart of example method 400 for adjusting at least part of a storage space of a storage pool to a spare space according to an embodiment of the present disclosure. For example, method 400 may be performed by storage pool management device 110 as shown in FIG. 1. Method 400 is an example embodiment of 350 in method 300. It should be understood that method 400 may also be performed by other devices, and the scope of the present disclosure is not limited in this regard. It should also be understood that method 400 may also include additional actions not shown and/or omit the actions shown, and the scope of the present disclosure is not limited in this regard.

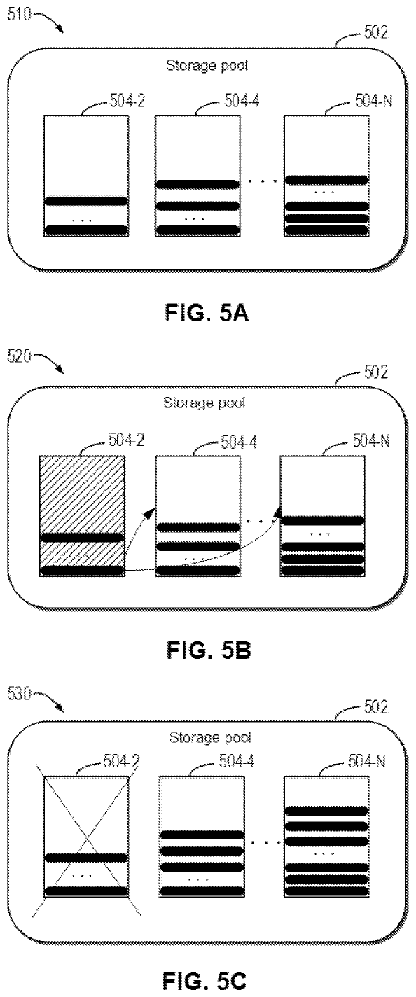

FIG. 4 is described below with reference to FIG. 5. FIG. 5A shows schematic diagram 510 of a storage pool before the adjustment of at least part of a storage space of the storage pool to a spare space. FIG. 5B shows schematic diagram 520 of a storage pool during the adjustment of at least part of a storage space of the storage pool to a spare space. FIG. 5C shows schematic diagram 530 of a storage pool after the adjustment of at least part of a storage space of the storage pool to a spare space.

At 410, storage pool management device 110 replicates first data stored in a target disk array group to the remaining disk array groups in a plurality of disk array groups. In some embodiments, storage pool management device 110 may uniformly replicate the first data stored in the target disk array group to other disk array groups. In some embodiments, storage pool management device 110 may replicate the first data stored in the target disk array group to a designated disk array group, as long as a free space of the disk array group is sufficient to accommodate the first data stored in the target disk array group.

As shown in FIG. 5A, there are a plurality of disk array groups 504-2 to 504-N (collectively referred to as “disk array group 504”) in storage pool 502. Assuming that storage pool management device 110 has determined from disk array groups 504-2 to 504-N that disk array group 504-2 is the target disk array group, storage pool management device 110 may uniformly replicate slices in target disk array group 504-2 to other disk array groups 504-4 to 504-N.

Additionally, in some embodiments, storage pool management device 110 may set a freeze indicator for the target disk array group to set the target disk array group as “read-only” during data replication from the target disk array group to other disk array groups. In this case, write operations and move operations to the target disk array group will be stopped. Input and output operations for the target disk array group may be reoriented to other disk array groups.

After the first data stored in the target disk array group is all replicated to the remaining disk array groups in the plurality of disk array groups, at 420, storage pool management device 110 releases the storage space of the target disk array group. As shown in FIG. 5C, when all the data in target disk array group 504-2 is replicated to disk array groups 504-4 to 504-N, the storage space of target disk array group 504-2 is released.

In some cases, if data replication from the target disk array group to other disk array groups is terminated due to an unexpected situation, storage pool management device 110 may restore the target disk array group to an initial state before data replication.

At 430, storage pool management device 110 sets at least part of the released storage space as a spare space.

In some embodiments, storage pool management device 110 may set a storage space of the same size as one storage device 130 in the released storage space as a spare space. Alternatively, in some embodiments, storage pool management device 110 may set a storage space of which the size is a multiple of the storage space of storage device 130 as a spare space. Additionally, in some embodiments, storage pool management device 110 may select the released storage space of the same size from each storage device 130 to be combined into a spare space.

In some embodiments, storage pool management device 110 may also determine the size of a residual space in the released storage space that is not set as the spare space. If storage pool management device 110 determines that the size of the residual space is greater than or equal to the size of the space of one storage device, at least part of the residual space is set as a new disk array group. For example, storage pool management device 110 may set a storage space of the same size as one storage device 130 in the residual space as a new disk array group. Storage pool management device 110 may also set a storage space in the residual space that is a multiple of the storage space of one storage device 130 as a new disk array group.

In the above example embodiment, it is possible to increase the redundancy of a storage pool by adjusting at least part of a storage space of the storage pool to a spare space. In addition, by setting a residual space in the released storage space that is not set as the spare space as a new disk array group, the released storage space can be fully utilized.

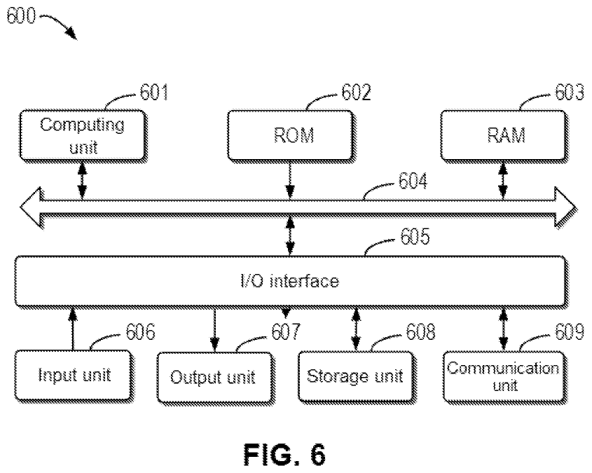

FIG. 6 is a schematic block diagram of example device 600 that may be configured to implement an embodiment of the present disclosure. For example, storage pool management device 110 as shown in FIG. 1 may be implemented by device 600. As shown in FIG. 6, device 600 includes central processing unit (CPU) 601, which may execute various appropriate actions and processing in accordance with computer program instructions stored in read-only memory (ROM) 602 or computer program instructions loaded from storage unit 608 onto random access memory (RAM) 603. In RAM 603, various programs and data required for the operation of device 600 may also be stored. CPU 601, ROM 602, and RAM 603 are connected to each other through bus 604. Input/output (I/O) interface 605 is also connected to bus 604.

A plurality of components in device 600 are connected to I/O interface 605, including: input unit 606, such as a keyboard and a mouse; output unit 607, such as various types of displays and speakers; storage unit 608, such as a magnetic disk and an optical disk; and communication unit 609, such as a network card, a modem, and a wireless communication transceiver. Communication unit 609 allows device 600 to exchange information/data with other devices over a computer network such as the Internet and/or various telecommunication networks.

The various processes and processing described above, such as methods 300 and 400, may be performed by processing unit 601. For example, in some embodiments, methods 300 and 400 may be implemented as a computer software program that is tangibly included in a machine-readable medium such as storage unit 608. In some embodiments, part or all of the computer program may be loaded and/or installed onto device 600 via ROM 602 and/or communication unit 609. When the computer program is loaded to RAM 603 and executed by CPU 601, one or more actions of methods 300 and 400 described above may be executed.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions for use by an instruction-executing device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device such as a punch card or a raised structure in a groove having instructions stored thereon, and any suitable combination thereof. The computer-readable storage medium used here is not construed as transient signals per se, such as radio waves or other freely propagating electromagnetic waves, electromagnetic waves propagating through waveguides or other transfer media (for example, optical pulses through fiber-optic cables), or electrical signals transmitted through electrical wires.

The computer-readable program instructions described herein may be downloaded from a computer-readable storage medium to various computing/processing devices, or downloaded to an external computer or external storage device via a network such as the Internet, a local area network, a wide area network, and/or a wireless network. The network may include copper transmission cables, optical fiber transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages. The programming languages include object-oriented programming languages such as Smalltalk and C++ and conventional procedural programming languages such as “C” language or similar programming languages. The computer-readable program instructions may be executed entirely on a user computer, partly on a user computer, as a standalone software package, partly on a user computer and partly on a remote computer, or entirely on a remote computer or a server. In the case where a remote computer is involved, the remote computer may be connected to a user computer over any kind of networks, including a local area network (LAN) or a wide area network (WAN), or may be connected to an external computer (e.g., connected over the Internet using an Internet service provider). In some embodiments, an electronic circuit, such as a programmable logic circuit, a field-programmable gate array (FPGA), or a programmable logic array (PLA), is customized by utilizing state information of the computer-readable program instructions. The electronic circuit may execute the computer-readable program instructions so as to implement various aspects of the present disclosure.

Various aspects of the present disclosure are described here with reference to flowcharts and/or block diagrams of the methods, the apparatuses (systems), and the computer program products according to the embodiments of the present disclosure. It should be understood that each block in the flowcharts and/or block diagrams as well as a combination of blocks in the flowcharts and/or block diagrams may be implemented by using computer-readable program instructions.

The computer-readable program instructions may be provided to a processing apparatus of a general purpose computer, a special purpose computer, or another programmable data processing apparatus to produce a machine, such that the instructions, when executed by the processing apparatus of the computer or another programmable data processing apparatus, generate an apparatus for implementing the functions/actions specified in one or more blocks in the flowcharts and/or block diagrams. The computer-readable program instructions may also be stored in a computer-readable storage medium. These instructions cause a computer, a programmable data processing apparatus, and/or another device to operate in a particular manner, such that the computer-readable medium storing the instructions includes an article of manufacture that includes instructions for implementing various aspects of the functions/actions specified in one or more blocks in the flowcharts and/or block diagrams.

The computer-readable program instructions may also be loaded onto a computer, other programmable data processing apparatuses, or other devices, so that a series of operating steps are performed on the computer, other programmable data processing apparatuses, or other devices to produce a computer-implemented process, so that the instructions executed on the computer, other programmable data processing apparatuses, or other devices implement the functions/actions specified in one or more blocks in the flowcharts and/or block diagrams.

The flowcharts and block diagrams in the accompanying drawings show the architectures, functionalities, and operations of possible implementations of the system, the method, and the computer program product according to a plurality of embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, the functions marked in the blocks may also occur in an order different from that marked in the accompanying drawings. For example, two successive blocks may actually be performed basically in parallel, or they may be performed in an opposite order sometimes, depending on the functions involved. It should be further noted that each block in the block diagrams and/or flowcharts as well as a combination of blocks in the block diagrams and/or flowcharts may be implemented by using a special hardware-based system for executing specified functions or actions or by a combination of special hardware and computer instructions.

The embodiments of the present disclosure have been described above. The above description is illustrative, rather than exhaustive, and is not limited to the disclosed embodiments. Numerous modifications and alterations are apparent to those of ordinary skill in the art without departing from the scope and spirit of the illustrated various embodiments. The selection of terms as used herein is intended to best explain the principles and practical applications of the various embodiments or technical improvements to technologies on the market, or to enable other persons of ordinary skill in the art to understand the various embodiments disclosed herein.

1. A method for managing a storage pool, comprising:
if it is detected that a storage pool fails, determining a number of failed storage devices in the storage pool;
if it is determined that the number reaches a threshold number, determining whether redundancy of the storage pool can be increased, the redundancy indicating the number of failed storage devices allowed without causing data loss in the storage pool; and
if it is determined that the redundancy of the storage pool can be increased, adjusting at least part of a storage space for storing user data of the storage pool to a spare space of the storage pool to store data in a storage device that fails in the future.

2. The method according to claim 1, wherein determining whether the redundancy of the storage pool can be increased comprises:
determining whether there is a target disk array group in a plurality of disk array groups distributed across the storage devices in the storage pool, a size of first data stored in the target disk array group being less than or equal to a size of a free storage space of remaining disk array groups in the plurality of disk array groups; and
if it is determined that there is the target disk array group in the plurality of disk array groups, determining that the redundancy of the storage pool can be increased.

3. The method according to claim 2, wherein adjusting at least part of the storage space to the spare space comprises:
replicating the first data stored in the target disk array group to the remaining disk array groups in the plurality of disk array groups;
releasing a storage space of the target disk array group; and
setting at least part of the released storage space as the spare space.

4. The method according to claim 3, further comprising:
determining a size of a residual space in the released storage space that is not set as the spare space; and
if it is determined that the size of the residual space is greater than or equal to the size of a space of one storage device in the storage pool, setting at least part of the residual space as a new disk array group.

5. The method according to claim 1, wherein determining whether the redundancy of the storage pool can be increased comprises:
if it is determined that the storage pool is accessible and there is no ongoing data replication process, determining whether there is a target disk array group in a plurality of disk array groups distributed across the storage devices in the storage pool, a size of first data stored in the target disk array group being less than or equal to a size of a free storage space of remaining disk array groups in the plurality of disk array groups; and
if it is determined that there is the target disk array group in the plurality of disk array groups, determining that the redundancy of the storage pool can be increased.

6. The method according to claim 5, wherein adjusting at least part of the storage space to the spare space comprises:
replicating the first data stored in the target disk array group to the remaining disk array groups in the plurality of disk array groups;
releasing a storage space of the target disk array group; and
setting at least part of the released storage space as the spare space.

7. The method according to claim 6, further comprising:
determining a size of a residual space in the released storage space that is not set as the spare space; and
if it is determined that the size of the residual space is greater than or equal to the size of a space of one storage device in the storage pool, setting at least part of the residual space as a new disk array group.

8. The method according to claim 1, wherein adjusting at least part of the storage space to the spare space comprises:
if a request for increasing the redundancy is received, adjusting the at least part of the storage space to the spare space.

9. An electronic device, comprising:
at least one processing unit; and
at least one memory coupled to the at least one processing unit and storing instructions configured to be executed by the at least one processing unit, wherein the instructions, when executed by the at least one processing unit, cause the device to perform actions comprising:
if it is detected that a storage pool fails, determining a number of failed storage devices in the storage pool;
if it is determined that the number reaches a threshold number, determining whether redundancy of the storage pool can be increased, the redundancy indicating the number of failed storage devices allowed without causing data loss in the storage pool; and
if it is determined that the redundancy of the storage pool can be increased, adjusting at least part of a storage space for storing user data of the storage pool to a spare space of the storage pool to store data in a storage device that fails in the future.

10. The electronic device according to claim 9, wherein determining whether the redundancy of the storage pool can be increased comprises:
determining whether there is a target disk array group in a plurality of disk array groups distributed across the storage devices in the storage pool, a size of first data stored in the target disk array group being less than or equal to a size of a free storage space of remaining disk array groups in the plurality of disk array groups; and
if it is determined that there is the target disk array group in the plurality of disk array groups, determining that the redundancy of the storage pool can be increased.

11. The electronic device according to claim 10, wherein adjusting at least part of the storage space to the spare space comprises:
replicating the first data stored in the target disk array group to the remaining disk array groups in the plurality of disk array groups;
releasing a storage space of the target disk array group; and
setting at least part of the released storage space as the spare space.

12. The electronic device according to claim 11, wherein the actions further comprise:
determining a size of a residual space in the released storage space that is not set as the spare space; and
if it is determined that the size of the residual space is greater than or equal to the size of a space of one storage device in the storage pool, setting at least part of the residual space as a new disk array group.

13. The electronic device according to claim 9, wherein determining whether the redundancy of the storage pool can be increased comprises:
if it is determined that the storage pool is accessible and there is no ongoing data replication process, determining whether there is a target disk array group in a plurality of disk array groups distributed across the storage devices in the storage pool, a size of first data stored in the target disk array group being less than or equal to a size of a free storage space of remaining disk array groups in the plurality of disk array groups; and
if it is determined that there is the target disk array group in the plurality of disk array groups, determining that the redundancy of the storage pool can be increased.

14. The electronic device according to claim 13, wherein adjusting at least part of the storage space to the spare space comprises:
replicating the first data stored in the target disk array group to the remaining disk array groups in the plurality of disk array groups;
releasing a storage space of the target disk array group; and
setting at least part of the released storage space as the spare space.

15. The electronic device according to claim 14, wherein the actions further comprise:
determining a size of a residual space in the released storage space that is not set as the spare space; and
if it is determined that the size of the residual space is greater than or equal to the size of a space of one storage device in the storage pool, setting at least part of the residual space as a new disk array group.

16. The electronic device according to claim 9, wherein adjusting at least part of the storage space to the spare space comprises:
if a request for increasing the redundancy is received, adjusting the at least part of the storage space to the spare space.

17. A computer program product having a non-transitory computer readable medium which stores a set of instructions to manage a storage pool; the set of instructions, when carried out by computerized circuitry, causing the computerized circuitry to perform a method of:
in response to detecting failure of a storage pool, determining a number of failed storage devices in the storage pool;
in response to the number of failed storage devices in the storage pool reaching a threshold number, determining whether redundancy of the storage pool can be increased, the redundancy indicating the number of failed storage devices allowed without causing data loss in the storage pool; and
in response to determining that the redundancy of the storage pool can be increased, adjusting at least part of a storage space for storing user data of the storage pool to a spare space of the storage pool to store data in a storage device that fails in the future.
